(19) United States
(12) Patent Application Publication
(10) Pub. No.: US 2025/0103672 A1
(43) Pub. Date: Mar. 27, 2025

(54) LEARNING DEVICE, PRESENTATION DEVICE, LEARNING METHOD, AND STORAGE MEDIUM

(71) Applicant: NEC Corporation, Minato-ku, Tokyo (JP)

(72) Inventors: Tatsuya MATSUOKA, Tokyo (JP); Naoto OHSAKA, Tokyo (JP)

(73) Assignee: NEC Corporation, Minato-ku, Tokyo (JP)

(21) Appl. No.: 18/730,363

(22) PCT Filed: Mar. 30, 2022
(86) PCT No.: PCT/JP2022/015860

§ 371 Date: Jul. 19, 2024

(51) Int. Cl. G06F 17/11

(52) U.S. Cl. CPC G06F 17/11

(57) ABSTRACT

The learning device 1X mainly includes a solution generation means 15X and a learning means 16X. The solution generation means 15X generates solutions of an optimization problem. The learning means 16X generates a plurality of sets of solutions and train a model configured to determine a set of solutions to be outputted, based on one or more sets selected by an external input from the plurality of sets.

### TECHNICAL FIELD

The present disclosure relates to the technical field of a learning device, a presentation device, a learning method, and a storage medium for performing processing on an optimization problem.

### BACKGROUND

There are known systems for calculating a solution of an optimization problem. For example, Patent Literature 1 discloses a technique for evaluating an optimization result based on a plurality of indicators. Further, Patent Literature 2 discloses an optimization system capable of performing rematching by changing some trade conditions after determining a combination (performing matching) such that the trade conditions regarding commodities to be traded, such as the amount of trade and the price of trade, are satisfied between the sellers and the buyers. Further, Patent Literature 3 discloses a system for performing a business scheduling optimization in consideration of a plurality of indicators.

### CITATION LIST

### Patent Literature

Patent Literature 1: WO2013/179577

Patent Literature 2: WO2021/001977

Patent Literature 3: WO2021/059506

### SUMMARY

### Problem to be Solved

When an optimization problem is solved by optimization, a solution satisfying the formulated constraint conditions is obtained. On the other hand, the user may wish to determine the final solution to be adopted by comparing multiple solutions.

In view of the above-described issue, it is therefore an example object of the present disclosure to provide a learning device, a learning method, and a storage medium configured to perform learning for presenting multiple solutions with a variation according to user preference, and a presentation device configured to give a presentation based on the learning result.

### Means for Solving the Problem

In one mode of the learning device, there is provided a learning device including:
a solution generation means configured to generate solutions of an optimization problem; and
a learning means configured to
   generates a plurality of sets of solutions and
   train a model configured to determine a set of solutions to be outputted, based on one or more sets selected by an external input from the plurality of sets.

In one mode of the learning method, there is provided a learning method executed by a computer, the learning method including:
generating solutions of an optimization problem;
generating a plurality of sets of solutions; and
training a model configured to determine a set of solutions to be outputted, based on one or more sets selected by an external input from the plurality of sets.

In one mode of the storage medium, there is provided a storage medium storing a program executed by a computer, the program causing the computer to:
generate solutions of an optimization problem;
generate a plurality of sets of solutions; and
train a model configured to determine a set of solutions to be outputted, based on one or more sets selected by an external input from the plurality of sets.

### Effect

An example advantage according to the present invention is to suitably perform learning for presenting multiple solutions with a variation according to user preference.

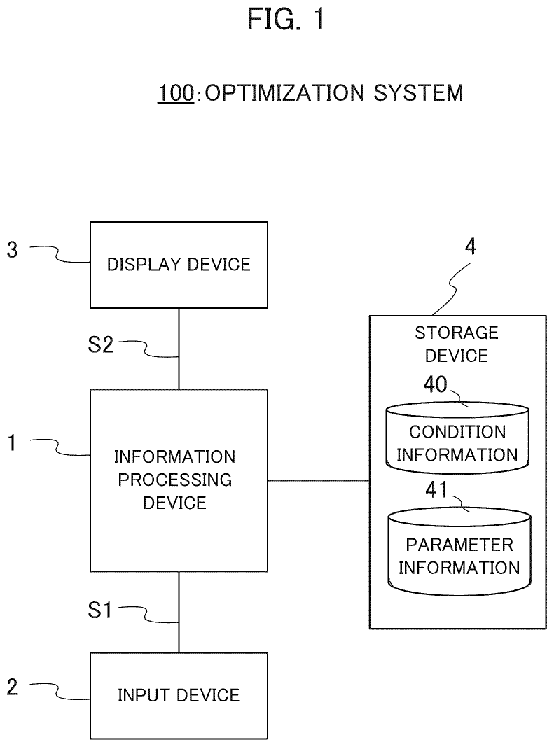

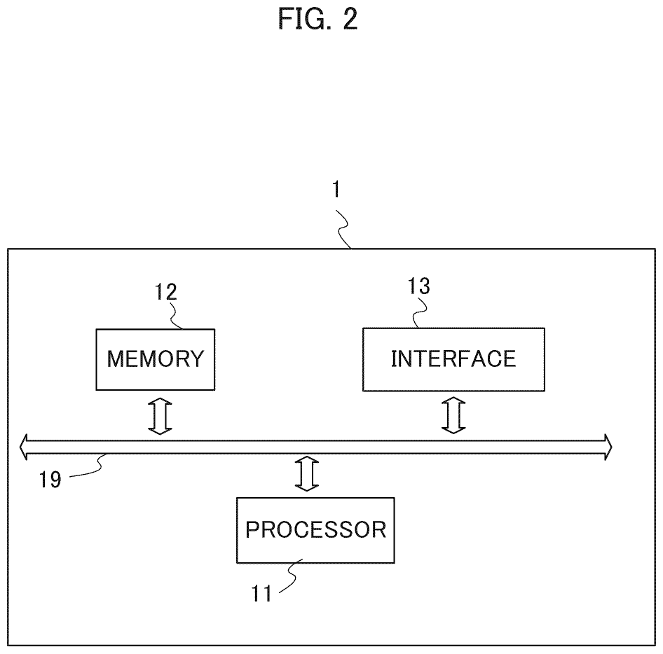

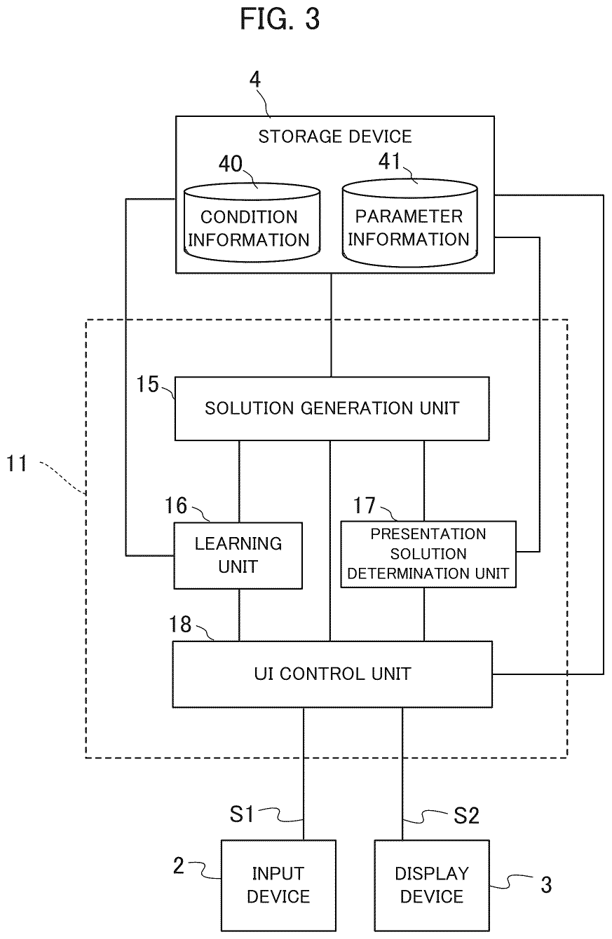

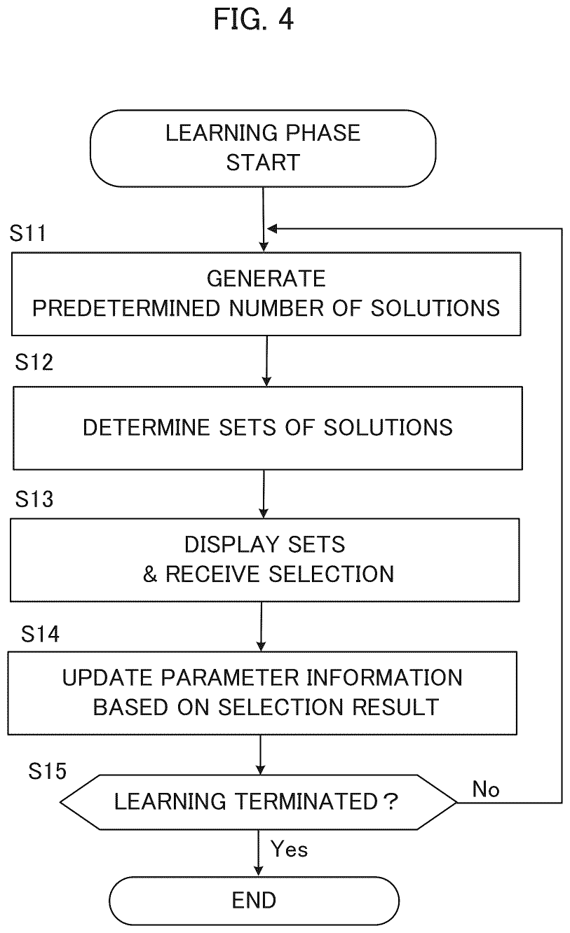

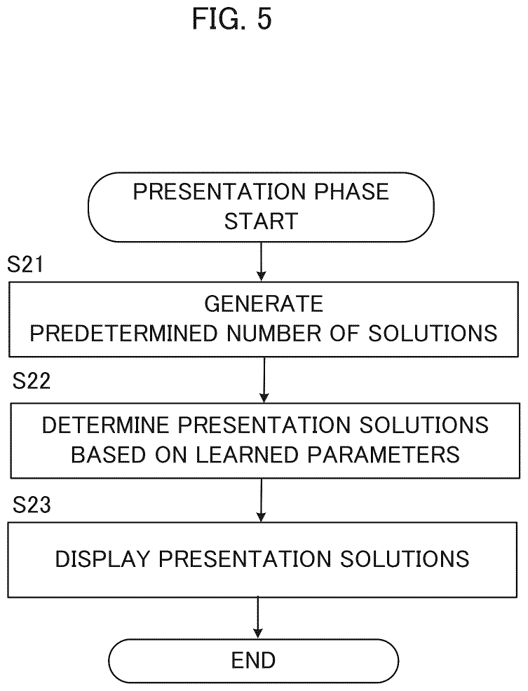

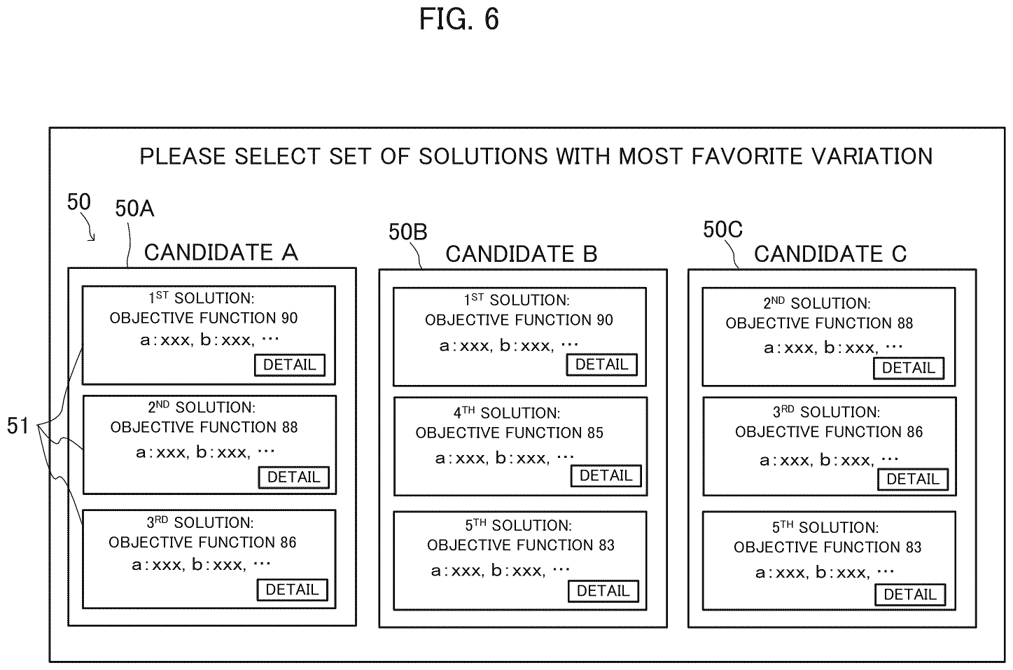

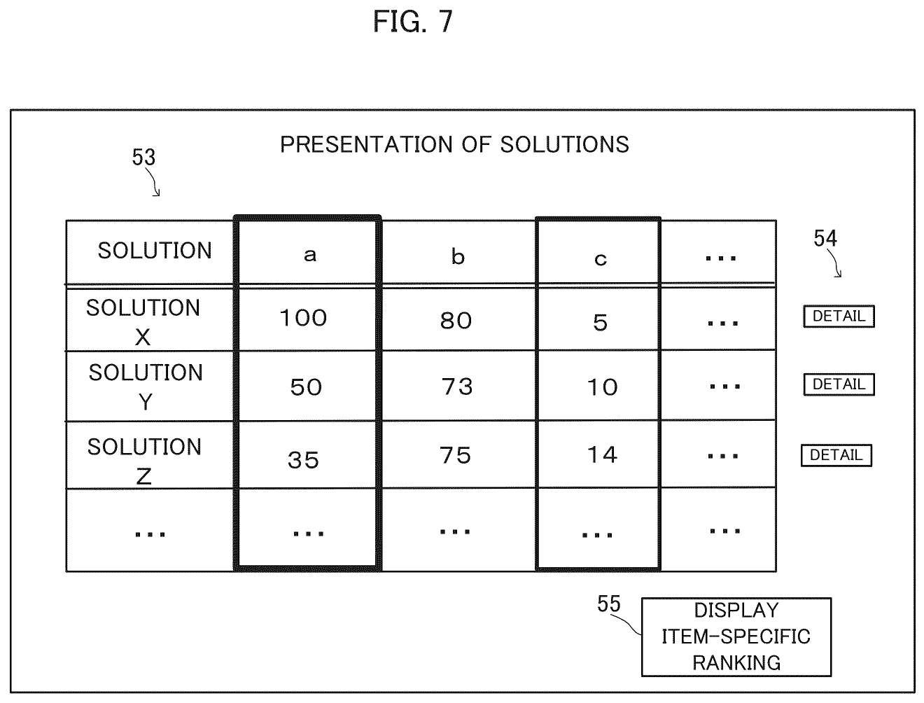

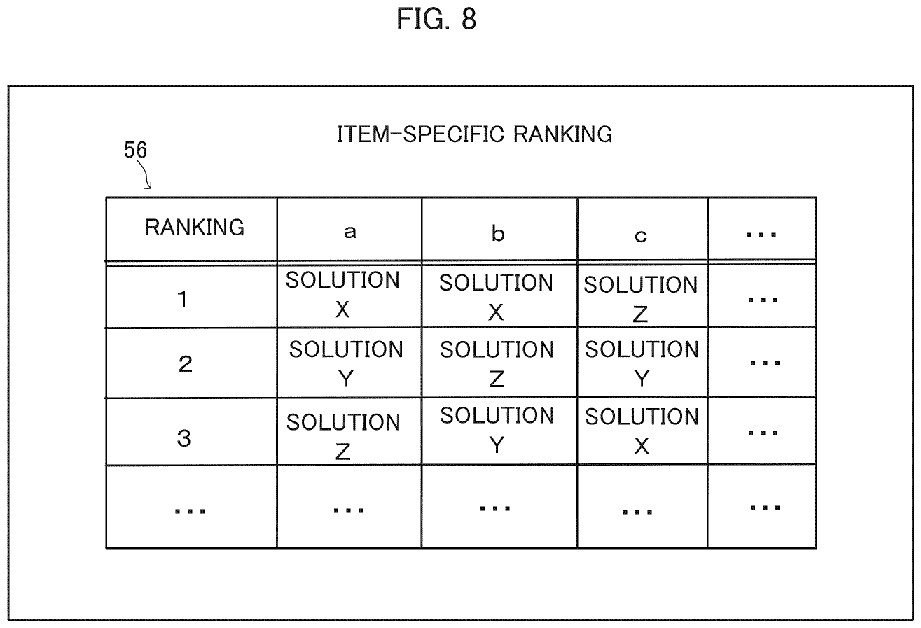

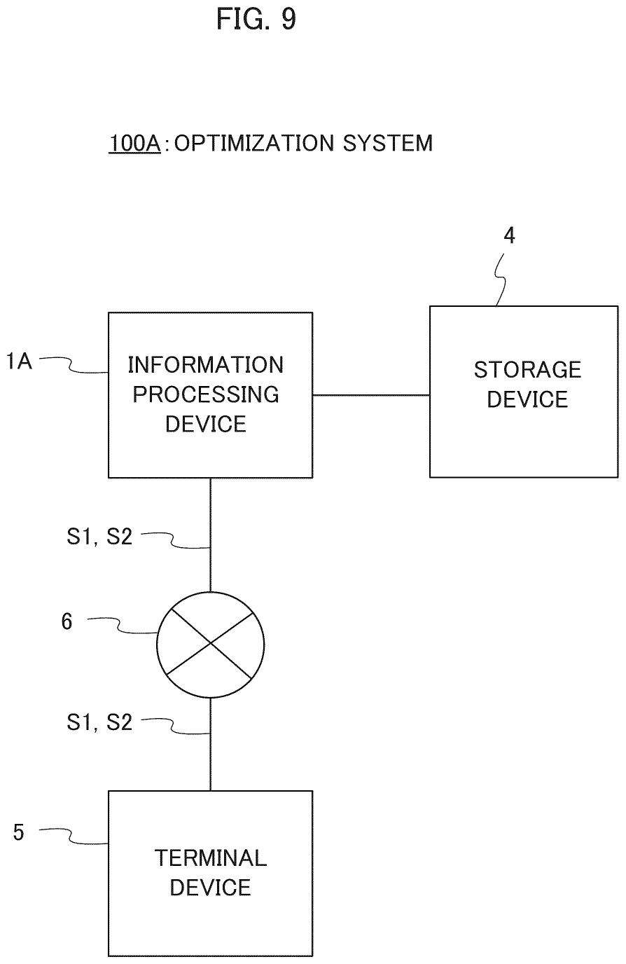

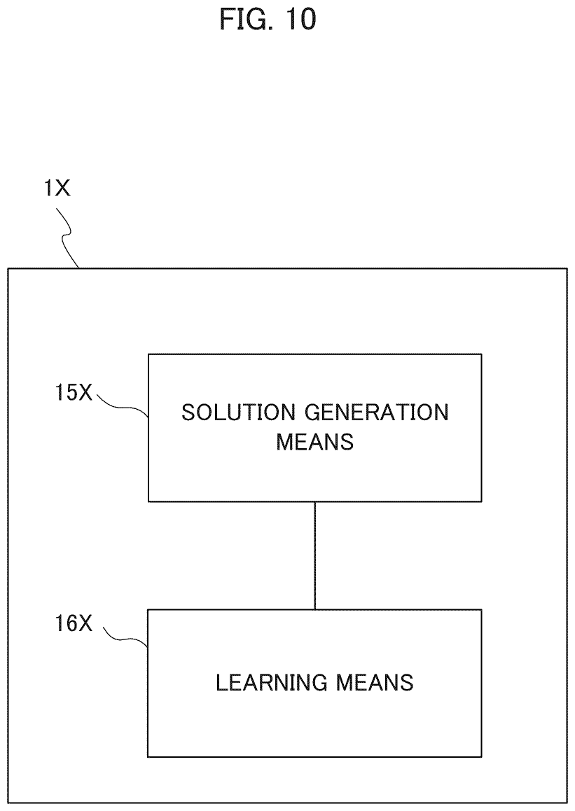

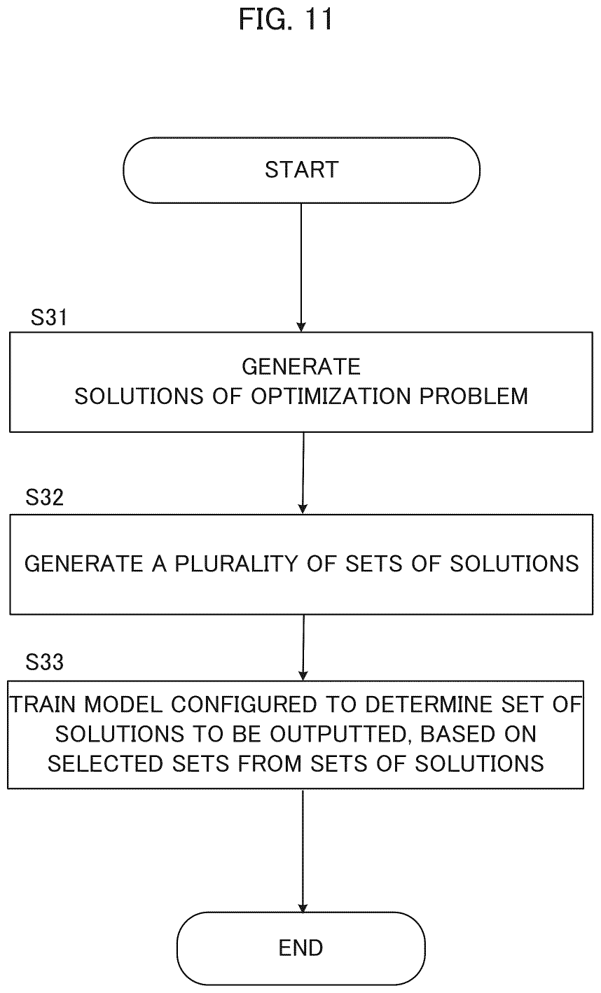

### BRIEF DESCRIPTION OF THE DRAWINGS

[FIG. 1] It illustrates the configuration of an optimization system according to a first example embodiment.

[FIG. 2] It illustrates a hardware configuration of the information processing device.

[FIG. 3] It is an example of a functional block diagram in the first example embodiment.

[FIG. 4] It is an example of a flowchart at a learning phase in the first example embodiment.

[FIG. 5] It is an example of a flowchart at a presentation phase in the first example embodiment.

[FIG. 6] It is a display example of a solution selection screen image.

[FIG. 7] It is a display example of a solution presentation screen image.

[FIG. 8] It is a display example of a ranking screen image.

[FIG. 9] It illustrates a configuration of an optimization system in a second example embodiment.

[FIG. 10] It is a functional block diagram of a learning device in a third example embodiment.

[FIG. 11] It is an example of a flowchart showing a processing procedure of the learning device in the third example embodiment.

### EXAMPLE EMBODIMENTS

Hereinafter, example embodiments of a learning device, a presentation device, a learning method, and a storage medium will be described with reference to the drawings.

### First Example Embodiment

### (1) System Configuration

FIG. 1 shows a configuration of an optimization system 100 according to a first example embodiment. The optimization system 100 mainly includes an information processing device 1, an input device 2, a display device 3, and a storage device 4.

The information processing device 1 performs processing related to optimization in a designated optimization problem. In the present example embodiment, the information processing device 1 calculates multiple solutions for the designated optimization problem and presents multiple solutions (which may be a transition sequence of solutions; hereinafter the same applies). In this case, for presenting multiple solutions, the information processing device 1 performs learning so that it can present multiple solutions with variations according to the priority given by a user of the optimization system 100. Thereafter, the stage (phase) of learning to present multiple solutions with the variations according to the user's priority is referred to as “learning phase”, and the phase of presenting multiple solutions of the optimization problem designated by the user using the parameters obtained through the learning is referred to as “presentation phase”. It is noted that the learning phase is not a mandatory process, and the user can select whether or not to execute the learning phase. The information processing device 1 is an example of the “learning device” and the “presentation device”.

It should be noted that the optimization problem may be, for example, a problem of determining a combination between sellers and buyers regarding target commodities of transaction (and a transportation schedule for the target commodities), a problem of determining a working shift of employees, or any other combination optimization problem. Examples of the commodities described above include a fuel such as LNG, a steel, machinery, electronics, a fiber, a chemical, medical-related goods, food, and any other commodity.

The information processing device 1 performs data communication with the input device 2, the display device 3, and the storage device 4 through a communication network or through direct wireless or wired communication.

The input device 2 is one or more interfaces for receiving a user input that is an external input, and examples of the input device 2 include a touch panel, a button, a keyboard, and a voice input device. The input device 2 supplies the input information “S1” generated based on the input from the user to the information processing device 1.

The display device 3 is, for example, a display, a projector, and/or the like, and displays information on the basis of display information “S2” supplied from the information processing device 1.

The storage device 4 is one or more memories for storing various information necessary for optimization processing. For example, the storage device 4 stores condition information 40 and parameter information 41.

The condition information 40 is information (including setting information regarding the problem) on the conditions of the optimization problem to be solved by the information processing device 1. For example, if the problem of determining the combination between sellers and buyers regarding the target commodities of transactions is set as an optimization problem to be solved by the information processing device 1, the condition information 40 includes information (including the desired conditions of each seller regarding the place of delivery, delivery period, amount of transactions, and price) regarding the sellers of the target commodities of transactions, information (including the desired conditions of each buyer regarding the place of delivery, delivery period, amount of transactions, and price) regarding the buyers of the target commodities of transactions, and the like. In some embodiments, the condition information 40 may store the condition information of the optimization problem to be targeted in the learning phase and the condition information of the optimization problem to be targeted in the presentation phase, respectively.

The parameter information 41 is information on parameters of a model (also referred to as “presentation solution determination model”) for determining multiple solutions (also referred to as “presentation solutions”) to be presented to the user. The presentation solution model is, for example, a learning model that is trained to output information indicating a set of multiple solutions to be presented when a plurality of sets of multiple solutions serving as candidates for the presentation solutions are inputted to the model. The presentation solution determination model may have an architecture of any machine learning model, such as a neural network, a support vector machine, and the like. For example, if the presentation solution model has an architecture of a neural network such as a convolutional neural network, the parameter information 41 includes information regarding the layer structure, the neuron structure of each layer, the number of filters and the filter size in each layer, and the weight for each element of each filter. In some embodiments, before the learning phase is performed, as the parameter information 41, information indicating predetermined initial parameters may be stored in the storage device 4.

The storage device 4 may be an external storage device such as a hard disk connected or embedded in the information processing device 1, or may be a storage medium such as a flash memory. The storage device 4 may be a server device that performs data communication with the information processing device 1. In this case, the storage device 4 may be configured of a plurality of server devices.

The configuration of the optimization system 100 shown in FIG. 1 is an example, and various changes may be made to the configuration. For example, the input device 2 and the display device 3 may be configured integrally. In this case, the input device 2 and the display device 3 may be configured as a tablet type terminal that is integrated with the information processing device 1. Further, the information processing device 1 may be configured of a plurality of devices. In this case, the plurality of devices constituting the information processing device 1 performs transmission and reception of information necessary for executing preassigned processing among the plurality of devices.

### (2) Hardware Configuration of Information Processing Device

FIG. 2 shows a hardware configuration of the information processing device 1. The information processing device 1 includes a processor 11, a memory 12, and an interface 13 as hardware. The processor 11, the memory 12 and the interface 13 are connected to one another via a data bus 19.

The processor 11 executes a predetermined process by executing a program stored in the memory 12. The processor 11 is one or more processors such as a CPU (Central Processing Unit), a GPU (Graphics Processing Unit), and a TPU (Tensor Processing Unit). The processor 11 may be configured of a plurality of processors. The processor 11 is an example of a computer.

The memory 12 is configured by various volatile memories and non-volatile memories such as a RAM (Random Access Memory) and a ROM (Read Only Memory). Further, a program for the information processing device 1 to execute various kinds of process is stored in the memory 12. The memory 12 is used as a working memory to temporarily store information and the like acquired from the storage device 4. The memory 12 may function as a storage device 4. The storage device 4 may function as the memory 12 of the information processing device 1. The program executed by the information processing device 1 may be stored in a storage medium other than the memory 12.

The interface 13 is one or more interfaces for electrically connecting the information processing device 1 to other devices. Examples of the interfaces include a wireless interface, such as a network adapter, for transmitting and receiving data to and from other devices wirelessly, and a hardware interface, such as a cable, for connecting to other devices.

The hardware configuration of the information processing device 1 is not limited to the configuration shown in FIG. 2. For example, the information processing device 1 may incorporate at least one of the input device 2 and/or the display device 3. In another example, the information processing device 1 may incorporate or be connected to a sound output device such as a speaker.

### (3) Functional Blocks

FIG. 3 is an example of a functional block diagram of the processor 11 in the first example embodiment. The processor 11 functionally includes a solution generation unit 15, a learning unit 16, a presentation solution determination unit 17, and a UI (User Interface) control unit 18. Further, in FIG. 3, any blocks to exchange data with each other are connected by a solid line, but the combinations of the blocks to exchange data with each other are not limited to FIG. 3. The same applies to the drawings of other functional blocks described below.

The solution generation unit 15 determines solutions of the optimization problem. In this case, based on the condition information 40 regarding the optimization problem stored in the storage device 4, the solution generation unit 15 calculates multiple solutions for the optimization problem. In this case, for example, the solution generation unit 15 calculates a predetermined number of solutions larger than the number of solutions to be presented as presentation solutions. In some embodiments, in order to obtain the predetermined number of solutions, the solution generation unit 15 may relax the constraint conditions indicated by the condition information 40 to calculate an optimum solution for each relaxed set of constraint conditions. The degree of relaxation of the constraint conditions in this case may be determined based on the user input.

The solution determination unit 15 may determine the solutions of the optimization problem based on an arbitrary optimization method (optimization solver). For example, when solving a problem of determining a combination of sellers and buyers regarding the target commodities of transactions, the solution determination unit 15 formulates the problem as an integer programming problem by regarding the problem as a single combination optimization problem. The solution determination unit 15 obtains a solution of the formulated integer programming problem by performing the processing equivalent to a typical application program (e.g., IBM ILOG CPLEX, Gurobi Optimizer, SCIP). A determination method of the sellers, buyers, the ships to be used, and each navigation period of the ships by setting an integer programming problem is, for example, disclosed in Patent Literature 2 and the like.

The learning unit 16 updates the parameter information 41 through the learning phase. In this case, the learning unit 16 generates a plurality of sets of multiple solutions (i.e., generates a plurality of candidates for the presentation solutions), on the basis of the calculation result of the solution generation unit 15 and presents these sets to the user in a selectable manner. In this case, for example, the learning unit 16 performs random extractions from the solutions calculated by the solution generation unit 15 to thereby generate the plurality of sets of solutions. Then, the learning unit 16 uses a set of multiple solutions selected by the user input from the plurality of sets of multiple solutions as multiple solutions representing a correct answer (i.e., solutions having a variation that the user prefers). Accordingly, the learning unit 16 generates such training data of the presentation solution determination model that the plurality of sets of multiple solutions presented to the user as options are used as the input data and the set of the multiple solutions selected by the user input is used as the correct answer data. In the learning of the presentation solution model using the training data described above, the learning unit 16 determines the parameters of the presentation solution determination model so as to minimize the error (loss) between the data outputted by the presentation solution determination model when the input data is inputted to the presentation solution determination model and the correct answer data corresponding to the input data. The algorithm for determining the parameters to minimize the loss may be any learning algorithm used in machine learning, such as the gradient descent method and the error back propagation method.

The presentation solution determination unit 17 determines the presentation solutions which are N (N is an integer greater than or equal to 2) solutions to be presented to the user at the presentation phase. In this case, the presentation solution determination unit 17 determines the presentation solutions based on the solutions calculated by the solution generation unit 15 and the presentation solution model to which the parameters indicated by the parameter information 41 are applied. In this case, for example, the presentation solution unit 17 generates a plurality of sets of candidates for the presentation solutions and determines the presentation solutions based on information outputted by the presentation solution determination model when these a plurality of sets are inputted to the presentation solution determination model. The number N may be stored in advance in the storage device 4 or the like, or may be determined based on the user input. The presentation solution determination unit 17 is an example of the “determination means”.

The UI control unit 18 receives the user input and controls the display of the information to be browsed by the user at the learning phase and at the presentation phase of the learning unit 16 and the presentation solution unit 17. In this instance, based on the input information S1 supplied from the input device 2, the UI control unit 18 accepts a user input, or performs display control of the display device 3 by supplying the display information S2 to the display device 3. Specific processes executed by the UI control unit 18 will be described later with reference to display examples. The UI control unit 18 is an example of the “control means” and the “presentation means”.

Each component of the solution generation unit 15, the learning unit 16, the presentation solution determination unit 17, and UI control unit 18 described in FIG. 3 can be realized, for example, by the processor 11 executing a program. The necessary programs may be recorded on any non-volatile storage medium and installed as necessary to realize each component. It should be noted that at least a portion of these components may be implemented by any combination of hardware, firmware, and software, or the like, without being limited to being implemented by software based on a program. At least some of these components may also be implemented using a user programmable integrated circuit such as a FPGA (Field-Programmable Gate Array) and a microcontroller. In this case, the integrated circuit may be used to realize a program to function as each of the above components. Further, at least some of the components may be realized by ASSP (Application Specific Standard Produce), ASIC (Application Specific Integrated Circuit), or quantum processor (quantum computer control chip). Thus, each component may be implemented by various hardware. The above is also true for other example embodiments described later. Furthermore, each of these components may be implemented by the cooperation of a plurality of computers, for example, using cloud computing technology.

### (4) Processing Flow

FIG. 4 is an example of a flowchart that is executed by the information processing device 1 at the learning phase according to the first example embodiment.

First, the solution generation unit 15 generates a predetermined number of solutions of the optimization problem identified by the condition information 40 (step S11). In this case, the predetermined number is set to a value greater than N. Next, the learning unit 16 determines a plurality of sets of multiple solutions (step S12). In this case, for example, the learning unit 16 generates a predetermined number of sets of N solutions. In this case, the learning unit 16 may generate the predetermined number of sets based on any method.

Next, the UI control unit 18 displays the plurality of sets of the multiple solutions determined at step S12 on the display device 3 and receives an input for selecting a set of multiple solutions having a variation preferable for the user from the plurality of sets of the multiple solutions (step S13). Upon receiving the input information S1 representing the user's selection result from the input device 2, the UI control unit 18 notifies the learning unit 16 of the user's selection result.

Next, the learning unit 16 updates the parameter information 41 based on the selection result received at step S13 (step S14). In this case, for example, the learning unit 16 uses the selected set of the multiple solutions as the correct answer data indicative of the presentation solutions and determines the parameters of the presentation solution determination model to minimize the error between the output result from the presentation solution determination model and the correct answer data.

Then, the learning unit 16 determines whether or not to terminate the learning (step S15). For example, the learning unit 16 may make the above-described determination on the basis of whether or not the process at step S14 has been performed by a predetermined number of times, or may make the above-described determination on the basis of the user input. Upon determining that the learning should be terminated (step S15; Yes), the learning unit 16 terminates the process of the flowchart. On the other hand, upon determining that the learning should not be terminated (step S15; No), the learning unit 16 proceeds back to the process at step S11. Instead of proceeding back to the process at step S11, the learning unit 16 may proceed back to the process at step S12. In this instance, the learning unit 16 performs the process at step S12 based on the solutions generated in the process at step S11.

FIG. 5 is an example of a flowchart that is executed by the information processing device 1 at the presentation phase according to the first example embodiment.

First, when an optimization problem to be solved is designated based on the user input or the like, the solution generation unit 15 generates a predetermined number of solutions of the optimization problem (step S21). In this case, the predetermined number is set to a value greater than N.

Next, the presentation solution determination unit 17 determines the presentation solutions based on the learned parameters indicated by the parameter information 41 (step S22). In this case, for example, the presentation solution unit 17 determines the presentation solutions based on the information outputted by the presentation solution model when a plurality of sets of multiple solutions that are candidates for the presentation solutions are inputted to the presentation solution determination model configured based on the learned parameters.

Then, the UI control unit 18 causes the display device 3 to display the information relating to the presentation solutions determined by the presentation solution determination unit 17 (step S23). In this instance, the UI control unit 18 may highlight differences among the multiple solutions or display the ranking of solutions with respect to each item, which is an indicator for evaluating solutions. This display examples will be described later.

### (5) Display Examples

FIG. 6 is a display example of a solution selection screen image that is a screen image which the UI control unit 18 displays on the display device 3 at step S13 in FIG. 4, which is a learning phase. The UI control unit 18 generates the display information S2 for displaying the solution selection screen image based on the processing results at step S11 and step S12, and transmits the generated display information S2 to the display device 3 through the interface 13, thereby causing the display device 3 to display the solution selection screen image.

The solution selection screen image includes candidate display fields 50 (50A to 50C) which indicate information regarding the candidates (in this case, candidates A to C) for multiple solutions that are options to be selected by the user. Here, each candidate shows a set of three solutions, and each candidate display field 50 is provided with solution display fields 51 corresponding to the respective solutions. Each solution is assigned with an identification name (First Solution, Second Solution, . . . ) according to serial numbers, which are given in ascending order of values (objective function values) of objective functions used for optimization of the optimization problem. Here, as an example, it is assumed that the larger the objective function value is, the more preferable the solution is regarded to be.

Each solution display field 51 indicates the name of the corresponding solution, the objective function value, and the value of each item. In addition, each solution display field 51 is provided with a detail button for displaying detailed information regarding the corresponding solution. Here, each item (item a, item b, . . . ) is an indicator in the optimization problem, and it may be an indicator used in the expression of the objective function or constraint conditions, or may be a variable itself to be determined as a solution.

The candidate display fields 50 (50A to 50C) are selectable based on a user input, respectively, and the UI control 18 prompts the user to select a candidate display field 50 corresponding to the set of solutions that has the most favorable variation for the user. Upon determining that one candidate display field 50 is selected based on a clicking operation, a touch operation, or the like on the solution selection screen image, the UI control unit 18 receives input information S1 indicating the selected candidate display field 50 from the input device 2 and supplies a selection result indicated by the input information S1 to the learning unit 16. Thereafter, if the learning phase is continued, the UI control unit 18 displays a solution selection screen image indicating new candidates for the solutions on the display device 3 and receives the selection of a set of the multiple solutions having a variation preferable for the user.

Generally, what should be prioritized depends on the user, and there are users who prioritize the diversity, or users who prioritize a particular item being within a predetermined value range. In view of the above, the information processing device 1 receives the selection of the set of the multiple solutions having a variation preferable for the user on the solution selection screen image. Thus, the information processing device 1 can suitably obtain data for learning a tendency of the user's priority.

FIG. 7 is a display example of the solution presentation screen image that is a screen image which the UI control unit 18 displays on the display device 3 at step S23 in FIG. 5, which is a presentation phase. The UI control unit 18 generates display information S2 for displaying the solution presentation screen image based on the process results at step S21 and step S22, and transmits the generated display information S2 to the display device 3 through the interface 13, thereby causing the display device 3 to display the solution presentation screen image.

The UI control unit 18 displays a presentation solution table 53 showing, for each item, the details of the presentation solutions (solution X, solution Y, solution Z, . . . ) determined at step S22 on the solution presentation screen image. The presentation solution table 53 includes records for respective solutions, each of which is provided with a detailed button 54 for viewing detailed information regarding the corresponding solution.

In addition, the UI control unit 18 highlights any items, in the presentation solution table 53, in which the difference is remarkable among the presentation solutions. Here, the UI control unit 18 highlights, by the edging effect, the top two items (item “a” and item “c”) in terms of the dispersion (variance) in the presented solutions. Specifically, the UI control unit 18 surrounds the item “a” having the largest variance in the presentation solutions by a thick frame, and surrounds the item c having the second largest variance in the presentation solution by a thin frame. The UI control unit 18 may determine the number of items to be highlighted, the mode of highlight (including the thickness of the frame, the necessity of change in the background color and the like), or the like, based on the setting information generated based on the user input.

The presentation solutions herein displayed in the presentation solution table 53 are a combination in consideration of the trend of the sets of solutions chosen by the user in the learning phase (i.e., the trend of variations according to the user's priority). Therefore, the UI control unit 18 can prevent the display of a large number of solutions in a complicated manner and effectively display the solutions with a high degree of importance for the user.

Further, the UI control unit 18 displays the item-specific ranking display button 55 on the solution presentation screen image. Upon detecting that the item-specific ranking display button 55 is selected, the UI control unit 18 displays a screen image (also referred to as “ranking screen image”) for displaying the item-specific ranking among the presentation solutions on the display device 3. In some embodiments, each item of the presentation solution table 53 is selectable, and the UI control unit 18 generate the ranking screen image indicating the ranking regarding the item in a selected state in the presentation solution table 53 at the time of selection of the item-specific ranking display button 55.

FIG. 8 is a display example of the ranking screen image. For example, upon detecting that the item-specific ranking display button 55 is selected in the solution presentation screen image, the UI control unit 18 transmits the display information S2 to the display device 3 via the interface 13 to thereby display the ranking screen image on the display device 3.

The UI control unit 18 displays a ranking table 56 indicating the ranking among presentation solutions for each item on the ranking screen image. For example, the ranking with respect to item “a” is in the order of the solution X, the solution Y, and the solution Z. Here, the ranking for each item may be determined based on whether or not the item of interest is close to the predetermined optimum value (which may be a range; hereinafter the same applies). In another example, the ranking may be determined based on not only the closeness to the optimum value but also the objective function value of the solution. In the latter case, the weight for the closeness to the optimum value and the weight for the objective function value can be specified by the user, for example, and the setting values specified by the user input are stored in advance in the storage device 4 or the like.

In this way, the UI control unit 18 displays the ranking screen image. Therefore, the user can suitably grasp preferred solutions for each item.

### Second Example Embodiment

FIG. 9 shows the configuration of an optimization system 100A in the second example embodiment. As shown in FIG. 9, the optimization system 100A mainly includes an information processing device 1A, a storage device 4, and a terminal device 5. The information processing device 1A and the terminal device 5 perform data communication via the network 6 with each other.

The information processing device 1A performs a process related to the optimization. In this instance, the information processing device 1A receives the input information S1, which were received by the information processing device 1 from the input device 2 in the first example embodiment, from the terminal device 5 via the network 6. Further, the information processing device 1A transmits the display information S2, which were transmitted by the information processing device 1 to the display device 3 in the first example embodiment, via the network 6 to the terminal device 5. As such, the information processing device 1A according to the second example embodiment functions as a server device.

The terminal device 5 is a terminal equipped with an input function, a display function, and a communication function, and functions as the input device 2 and the display device 3 in the first example embodiment. The terminal device 5 may be, for example, a personal computer, a tablet-type terminal, a PDA (Personal Digital Assistant), or the like. The terminal device 5 transmits the input information S1 generated based on the received user input to the information processing device 1A through the network 6. Upon receiving the display information S2 from the information processing device 1A, the terminal device 5 displays various information based on the display information S2.

The information processing device 1A according to the second example embodiment can suitably execute the input processing and the display processing, which were executed by the information processing device 1 in the first example embodiment, for the user of the terminal device 5.

### Third Example Embodiment

FIG. 10 is a functional block diagram of the learning device 1X according to the third example embodiment. The learning device 1X mainly includes a solution generation means 15X and a learning means 16X. The learning device 1X may be configured by a plurality of devices.

The solution generation means 15X is configured to generate solutions of an optimization problem. Examples of the solution generation means 15X include the solution generation unit in the first example embodiment or the second example embodiment.

The learning means 16X is configured to generate a plurality of sets of solutions and train a model configured to determine a set of solutions to be outputted, based on one or more sets selected by an external input from the plurality of sets. Examples of the learning means 16X include the learning unit 16 according to the first example embodiment or the second example embodiment.

FIG. 11 is an example of the flowchart that is executed by the learning device 1X in the third example embodiment. First, the solution generation means 15X generates solutions of an optimization problem (step S31). Then, the learning means 16X generates a plurality of sets of solutions (step S32). Then, the learning means 16X trains a model configured to determine a set of solutions to be outputted, based on one or more sets selected by an external input from the plurality of sets (step S33).

When training such a model that determines a set of solutions, the learning device 1X according to the third example embodiment can train the model so as to determine the set of solutions that matches the preference of the user.

The whole or a part of the example embodiments described above can be described as, but not limited to, the following Supplementary Notes.

### Supplementary Note 1

A learning device comprising:
a solution generation means configured to generate solutions of an optimization problem; and
a learning means configured to
   generate a plurality of sets of solutions and
   train a model configured to determine a set of solutions to be outputted, based on one or more sets selected by an external input from the plurality of sets.

### Supplementary Note 2

The learning device according to Supplementary Note 1, further comprising
a control means configured to
   display the plurality of sets on a display device and
   receive the external input for selecting any set from the plurality of sets.

### Supplementary Note 3

The learning device according to Supplementary Note 1 or 2,
wherein the learning means is configured to
   repeatedly perform generation of the plurality of sets and selection from the plurality of sets and
   update parameters of the model, based on the one or more sets each obtained through the selection.

### Supplementary Note 4

The learning device according to any one of Supplementary Notes 1 to 3,
wherein the model is a learning model which is trained to output, when sets of the solutions are inputted to the model, information indicating a set of the solutions to be presented from the inputted sets.

### Supplementary Note 5

The learning device according to any one of Supplementary Notes 1 to 4,
wherein the set of solutions is presented to a person who made the external input.

### Supplementary Note 6

A presentation device comprising:
a solution generation means configured to generate solutions of an optimization problem;
a determination means configured to determine a set of solutions, based on
   the solutions generated by the solution generation means and
   a model trained by the learning device according to any one of Supplementary Notes 1 to 5; and
a presentation means configured to present the set of the solutions.

### Supplementary Note 7

The presentation device according to Supplementary Note 6,
wherein the presentation means is configured to present a table indicating a value of each solution of the set of the solutions with respect to each item.

Supplementary Note 8

The presentation device according to Supplementary Note 7,
wherein the presentation means is configured to determine an item to be highlighted in the table, based on a variation in the value of each solution with respect to each item.

### Supplementary Note 9

The presentation device according to any one of Supplementary Notes 6 to 8,
wherein the presentation means is configured to present an item-specific ranking among the set of the solutions.

### Supplementary Note 10

A learning method executed by a computer, the learning method comprising:
generating solutions of an optimization problem;
generating a plurality of sets of solutions; and
training a model configured to determine a set of solutions to be outputted, based on one or more sets selected by an external input from the plurality of sets.

### Supplementary Note 11

A storage medium storing a program executed by a computer, the program causing the computer to:
generate solutions of an optimization problem;
generate a plurality of sets of solutions; and
train a model configured to determine a set of solutions to be outputted, based on one or more sets selected by an external input from the plurality of sets.

In the example embodiments described above, the program is stored by any type of a non-transitory computer-readable medium (non-transitory computer readable medium) and can be supplied to a processor or the like that is a computer. The non-transitory computer-readable medium include any type of a tangible storage medium. Examples of the non-transitory computer readable medium include a magnetic storage medium (e.g., a flexible disk, a magnetic tape, a hard disk drive), a magnetic-optical storage medium (e.g., a magnetic optical disk), CD-ROM (Read Only Memory), CD-R, CD-R/W, a solid-state memory (e.g., a mask ROM, a PROM (Programmable ROM), an EPROM (Erasable PROM), a flash ROM, a RAM (Random Access Memory)). The program may also be provided to the computer by any type of a transitory computer readable medium. Examples of the transitory computer readable medium include an electrical signal, an optical signal, and an electromagnetic wave. The transitory computer readable medium can provide the program to the computer through a wired channel such as wires and optical fibers or a wireless channel.

While the invention has been particularly shown and described with reference to example embodiments thereof, the invention is not limited to these example embodiments. It will be understood by those of ordinary skilled in the art that various changes in form and details may be made therein without departing from the spirit and scope of the present invention as defined by the claims. In other words, it is needless to say that the present invention includes various modifications that could be made by a person skilled in the art according to the entire disclosure including the scope of the claims, and the technical philosophy. All Patent and Non-Patent Literatures mentioned in this specification are incorporated by reference in its entirety.

### DESCRIPTION OF REFERENCE NUMERALS

1, 1A Information processing device
1X Learning device
2 Input device
3 Display device
4 Storage device
5 Terminal device
100, 100A Optimization system

What is claimed is:

1. A learning device comprising:
at least one memory configured to store instructions; and
at least one processor configured to execute the instructions to:
generate solutions of an optimization problem;
generate a plurality of sets of solutions; and
train a model configured to determine a set of solutions to be outputted, based on one or more sets selected by an external input from the plurality of sets.

2. The learning device according to claim 1,
wherein the at least one processor is configured to further execute the instructions
display the plurality of sets on a display device and
receive the external input for selecting any set from the plurality of sets.

3. The learning device according to claim 1,
wherein the at least one processor is configured to execute the instructions
repeatedly perform generation of the plurality of sets and selection from the plurality of sets and
update parameters of the model, based on the one or more sets each obtained through the selection.

4. The learning device according to claim 1,
wherein the model is a learning model which is trained to output, when sets of the solutions are inputted to the model, information indicating a set of the solutions to be presented from the inputted sets.

5. The learning device according to claim 1,
wherein the set of solutions is presented to a person who made the external input.

6. A presentation device comprising:
at least one memory configured to store instructions; and
at least one processor configured to execute the instructions to:
generate solutions of an optimization problem;
determine a set of solutions, based on
the solutions generated by the solution generation means and
a model trained to determine a set of solutions to be outputted when sets of the solutions are inputted to the model; and
present the set of the solutions.

7. The presentation device according to claim 6,
wherein the at least one processor is configured to execute the instructions to present a table indicating a value of each solution of the set of the solutions with respect to each item.

8. The presentation device according to claim 7,
wherein the at least one processor is configured to execute the instructions to determine an item to be highlighted in the table, based on a variation in the value of each solution with respect to each item.

9. The presentation device according to claim 6,
wherein the at least one processor is configured to execute the instructions to present an item-specific ranking among the set of the solutions.

10. A learning method executed by a computer, the learning method comprising:
generating solutions of an optimization problem;
generating a plurality of sets of solutions; and
training a model configured to determine a set of solutions to be outputted, based on one or more sets selected by an external input from the plurality of sets.

11. (canceled)
